(19) United States
(12) Patent Application Publication
(10) Pub. No.: US 2009/0074907 A1
(43) Pub. Date: Mar. 19, 2009

(54) Injection-Molding Nozzle Shank System and a Method for Manufacturing Such a System

(76) Inventor: Herbert Gunther, Allendorf (DE)

Correspondence Address: CLARK & BRODY, 1090 VERMONT AVENUE, NW, SUITE 250, WASHINGTON, DC, 20005, US

(21) Appl. No.: 12/226,439

(22) PCT Filed: Mar. 30, 2007
(86) PCT No.: PCT/EP2007/002897

§ 371 Date: Oct. 17, 2008

(30) Foreign Application Priority Data
Apr. 19, 2006 (DE) 10 2006 018 336.3

(51) Int. Cl. B29C 45/20; B23P 15/26

(52) U.S. Cl. 425/549; 29/890.036

(57) ABSTRACT

A shank system (10) for an injection molding nozzle (1) fitted with a heated injection material feeding pipe (3) itself comprising at its end a nozzle tip (5), said system comprising a main shank part (20), a thermally insulating spacer part (30) and a terminal shank part (40), the main shank part (20) and the spacer part (30) enclosing the injection material feeding pipe (3) while being a radial distance from it, the terminal shank part (40) subtending a recess (41) receiving in sealing manner the free end (4) of the injection material feeding pipe (3). At their end sides the main shank part (20), the spacer part (30) and the terminal shank part (40) are fitted with recesses (21, 31, 32) to receive at least one adjacent shank part (20, 30, 40). Before the fashioning of an external processing contour (K), they each are fitted with a solder repository (23, 33) receiving annular solder elements (24, 34) to solder to each other all three components (20, 30, 40). The annular terminal part (40) is hardened by the soldering procedure for the purpose of increasing its resistance to wear, the soldering temperature being within the range of the transformation temperature of the substance of the terminal shank part (40).

The present invention relates to an injection-molding nozzle shank-system defined in claim 1, to a hot runner nozzle defined in claim 21 and to a method defined in claim 22 for manufacturing such an injection-molding shank system.

Injection molding nozzles are used in injection molding equipment to feed a fluid/flowable injection material at a predetermined temperature and high pressure to a separable mold insert. The injection material passing through the flow duct system must be kept fluid until it reaches the mold insert, therefore requiring accurate temperature control, while on the other hand said injection material must rapidly solidify inside the mold, in order to maintain short, economical operational cycles. Therefore heat losses from the mostly hot nozzle to the cold mold must be minimized, especially in the zone of the nozzle tip.

The document EP 0 927 617 B1 discloses a hot runner nozzle fitted with an externally heated injection material feeding pipe comprising at its end a nozzle tip. To attain uniform temperature distribution and to minimize heat losses, this injection material feeding pipe is mounted in a shank-like housing fitted at the lower zone of the injection material feeding pipe with a thermally poorly conducting cap. Said cap touches the mold only at a site far away from the nozzle tip and by its lower end constitutes a seat allowing the injection material feeding pipe to be centrally guided within it and thermally insulating said pipe in the nozzle tip zone from the mold. However different equipment thermal expansions/contractions arise during at the injection material feeding pipe and the shank cap, resulting in relative displacements, with danger that there may be substantial wear of the soft, thermally poorly conducting cap, and hence leakage.

The German patent document 41 27 036 C1 therefore proposes a multi-step shank system enclosing the injection material feeding pipe, comprising an outer sheath tube made of a high-strength tool steel and fitted with an adjoining spacer tube made of a low thermally conducting substance such as a chromium nickel steel, and an annular end zone made of a high-strength tool steel. This design does in fact reduce the wear between the end zone and the injection material feeding pipe. On the other hand the substance selection of the thermally poorly conducting separation tube is limited because, illustratively, titanium and steel cannot be welded to each other and screw connections would be cumbersome and costly.

Accordingly it is the objective of the present invention to eliminate the above cited and other drawbacks of the state of the art and to create a design for an injection-molding nozzle shank system allowing simple and economic manufacture and always providing optimal thermal insulation. Moreover the wear of the annular end zone shall be further reduced to assure unfailingly reliable operation of the injection molding nozzle. Moreover the manufacture of the shank system shall be both simple and economical.

The main features of the present invention are defined in claims 1, 21 and 22. Embodiments of the present invention are defined in claims 2 through 20 and 23 through 28.

Regarding an injection-molding nozzle shank system comprising a heated injection material feeding pipe fitted at its end with a nozzle tip consisting of a main shank part, a thermally insulating spacer part and a shank terminal part, where the shank main part and the spacer part enclose the injection material feeding pipe while being radially spaced from it and the shank terminal part constitutes a recess receiving in sealing manner the free injection material feeding pipe, the present invention provides that the shank main part, the spacer part and the shank terminal part are soldered to each other and that the terminal shank part is hardened.

In this manner optimal resistance to wear is always attained in the spacer part's end zone without thereby degrading the spacer part's thermal insulation effectiveness. The injection molding nozzle always is optimally tight and thereby permanently reliable injection molding nozzle operation is assured.

A hot runner nozzle fitted with a shank system of the present invention offers the advantage of always operating reliably because the hardened steel ring in the titanium cap protects it against frictional wear due to contact with the injection material feeding pipe.

The present invention also relates to a method for manufacturing an injection-molding nozzle shank system comprising an externally heated injection material feeding pipe fitted at its end with a nozzle tip, said shank system being constituted by a main shank part, a thermally insulating spacer part and a terminal shank part, said main shank part and the said spacer part enclosing the injection material feeding pipe at a radial distance from it, the terminal shank part subtending a recess receiving in sealing manner the free end of the injection material pipe, and said invention provides that the main shank part, the spacer part and the terminal shank part are soldered to each other and that the terminal shank part shall be hardened in the soldering process.

This surprisingly simple method of the invention also allows both rapid and efficient manufacture of shank systems. The components of said systems are connected to each other by soldering, the hardening procedure subsequent to soldering imparting high wear resistance to the terminal shank part.

Further features, details and advantages of the present invention are defined by the appended claims and elucidated in the following description of illustrative embodiment modes in relation to the attached drawings.

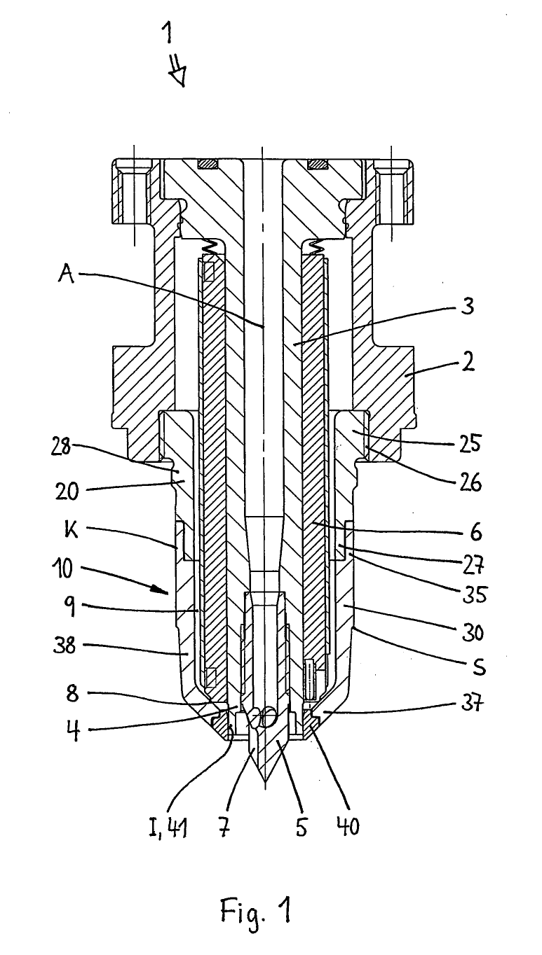

FIG. 1 is a lateral section of a shank system for a hot runner nozzle prior to final processing, and

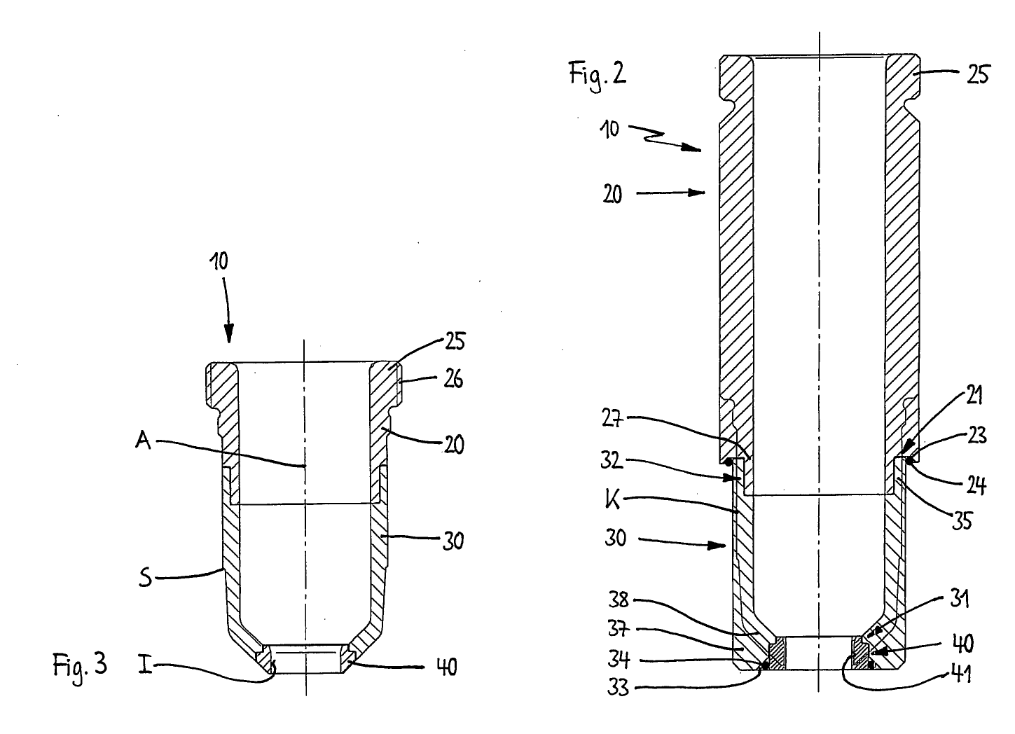

FIG. 2 is a lateral section of another shank system for a hot runner nozzle after final processing.

The injection molding nozzle denoted by the overall reference 1 in FIG. 1 is designed to be used in an otherwise omitted injection molding apparatus serving to manufacture molded components from a fluid/flowable material—for instance a plastic melt. Typically the injection molding apparatus comprises a clamping plate and parallel to it a manifold plate which is fitted with an array of flow ducts. The latter issue into several injection molding nozzles 1 which illustratively are designed as hot runner nozzles and which each are mounted by means of a housing 2 to the underside of the manifold plate.

An injection material feeding pipe 3 is inserted into each housing 2 and is fitted at its outer periphery with an electric heater 6. The injection material feeding pipe 3 ends in a nozzle tip 5 subtending terminally a nozzle discharge aperture 7. The material being processed is fed through said aperture and through an omitted sprue opening into a separable mold inset (also omitted).

In order to thermally shield the injection material pipe 3 and the heater 6 from the mold plates, the housing 2 continues in the direction of the nozzle tip 5 by a shank system 10. This shank system comprises a main shank part 20 made of a hardened tool steel, a cap-shaped spacer part 30 of a substance of low thermal conductivity and an annular, terminal shank part 40 also made of a hardened tool steel. Said terminal part constitutes a recess 41 having a substantially cylindrical inner contour I enclosing in sealing manner the free end 4 of the injection feeding pipe 3 in the displacement seat while the main shank part 20 and the spacer part 30 enclose the injection material feeding pipe 3 at a radial distance from it, as a result of which there remains a thermally insulating air gap 9—except for a narrow rest site 8 of the heater 6 against the spacer part 30—between the heater 6 and the shank system 10.

The overall cylindrical main shank part 20 is fitted at its upper end 25 with an external thread 26 by means of which it is screwed from below into the housing 2. The lower end 27 of the main shank part 20 is stepped and soldered to the upper end 35 of the spacer part 30. For that purpose said spacer part is fitted at its end face with a muff-like recess 32 receiving the lower end 27 of the upper shank part 20. At the same time the lower end 37 of the spacer part 30 constitutes also a stepped recess 31 receiving the terminal shank part 40. Said terminal part and the spacer part 30 also are soldered to each other.

FIGS. 1 and 3 show that the mutually soldered shank parts 20, 30, 40 jointly with the housing 2 are configured concentrically to the longitudinal axis A of the hot runner nozzle 1 and are fitted peripherally with an external processing contour K. Said contour subtends a step S approximately at half height of the spacer part 30, as a result of which the overall conically portion 38 of the cap 30 enclosing the terminal nozzle zone is seated free of contact in the mold. Accordingly a free space remains between the conical terminal portion 38 of the cap 30 that extends flush with the terminal shank part 40 and the mold, said space being able to receive injection material to be processed during operation of the hot runner nozzle 1. This feature enhances the insulating effect of the spacer part cap 30.

The external contour K is cylindrical above the step S. This zone is both a snug fit in the mold and a sealing and centering surface. To reliably preclude the highly pressurized plastic melt to be injected from penetrating the upper zone of the shank 10, the outer contour K of the shank 10 is provided below the thread 26 with a fit 28 in the form of a radial elevation. This elevation reliably seals the shank 10 from the mold and at the same time enhances centering the nozzle 1 in the mold.

As indicated, the main shank part 20 constitutes an upper shank part that can be screwed to the housing 2 of the injection molding nozzle 1. The spacer part 30 constitutes a cap which is preferably made of titanium or a similarly thermally poorly conducting substance and which at its end receives the terminal shank part 40. Preferably this terminal shank part 40 is annular and made of a tool steel which can be hardened. Preferably the upper shank part 20 is made of the same tool steel.

Whereas the shank system 10 is shown in FIGS. 1 and 3 in its final assembly form, in FIG. 2 the shank parts 20, 30, 40 yet to be soldered together are shown in the initial state of such assembly.

The spacer cap 30 is mounted on the upper shank part 20 which is fitted end-side with a recess 21 for the muff-like end 35 of the spacer cap 30. Said end 35 receives the stepped end portion 27 of the upper shank part 20, the components 20, 30 mechanically interlocking each other axially and radially down to an omitted gap between them. A solder repository 23 is constituted in the zone of the recess 21 of the upper shank part 20 peripherally next to the spacer cap 30 and receives an annular solder element 24.

The terminal shank part 40 is in the form of a steel ring and comprises a stepped external contour by means of which it is seated in geometrically interlocking manner in the end-side recess 31 of the spacer cap 30, a small gap remaining between latter and the steel ring 40. A further solder repository 33 is peripherally constituted next to the steel ring 40 and receives an annular solder element 34.

The end-side stepped recesses 21, 31, 32 in the upper shank part 20 and in the spacer part cap 30 assure that the shank system 10 can be mounted vertically, that is, the ring 40 and the spacer cap 30 are axially secured. Where called for the end-side recesses 21, 31, 32 also may be partly conical to enhance centering the components 20, 30, 40. The size of the gap between the shank parts 20, 30 respectively 30, 40 is between 0.02 and 0.2 mm to allow the solder 24, 34 to access, during soldering, the gaps between the components 20, 30, 40.

The shank parts 20, 30, 40 are soldered by placing the shank system 10 shown in FIG. 2 in an omitted soldering oven and heating them to the soldering temperature. The solder 24, 34 received in the solder repositories 23, 33 then melts and enters the gap between the shank upper part 20, the spacer part cap 30 and the steel ring 40 until, by capillarity, said gap has been entirely filled with solder.

The annular shank terminal part 40 is made of tool steel and already is hardened during soldering because, in the present invention, the selected soldering temperature is situated in the range of the transformation temperature of the particular selected tool steel of the main shank part 20 and the terminal shank part 40.

Following soldering, the terminal zone of the shank system 10 and hence of the terminal shank part 40 is quenched in a water or oil bath and then is tempered.

Following this treatment, the shank parts 20, 30, 40 are ground into their external processing contour K. The recess 41 of the terminal shank part 40 is fitted with the inside processing contour I in a manner that the injection material feeding pipe 3 is always guided in sealed manner in the steel ring 40 terminally inserted into the spacer part cap 30. Said ring 40 having been hardened by the soldering and processing procedure, the inevitable relative motion between the shank system 10 and the injection material feeding pipe 3 no longer entails undue wear. The entire system is sealed permanently, always assuring reliable injection molding nozzle operation. Moreover the injection material feeding pipe 3 is optimally thermally insulated, in particular in the zone of the nozzle tip 5, so that heat losses are all but precluded.

The present invention is not restricted to the above described embodiment modes, instead it may be modified in many ways. It must be borne in mind however that a shank system 10 for an injection molding nozzle 1 with a heated injection material feeding pipe 3 fitted end-side with a nozzle tip 5 comprises a main shank part 20, a thermally insulated spacer part 30 and a terminal shank part 40, the main shank part 20 and the spacer part 30 enclosing the injection material feeding pipe 3 while subtending a radial gap to it, whereas the terminal shank end 40 subtends a recess 41 receiving in sealing manner the free end of the injection material feeding pipe 3. At their end sides, the main shank part 20, the spacer part 30 and the terminal shank part 40 are fitted with recesses 21, 31, 32 for at least one adjacent shank part 20, 30, 40. They each comprise moreover, prior to fashioning an external processing contour K, a solder repository 23, 33 receiving annular solder elements 24, 34 in order that all three components 20, 30, 40 be soldered together. The annular terminal part 40 is hardened by the very soldering procedure in order to enhance resistance to wear, the soldering temperature being in the range of the transformation temperature of the substance of the terminal shank part 40.

All features and advantages, inclusive design details, spatial configurations and method steps implicit and explicit in the claims, specification and drawings, of the present disclosure, lend themselves to being construed inventive per se as well as in the most diverse combinations.

### List of References

A longitudinal axis
I inside processing contour
K outside processing contour
1 injection molding nozzle/hot-runner nozzle
2 housing
3 injection material feeding pipe
4 free end
5 nozzle tip
6 heater
7 nozzle discharge aperture
8 rest site
9 air gap
10 shank system
20 main shank part/upper shank part
21 recess
23 solder repository
24 solder
25 upper end
26 thread
27 lower end
28 fit
30 spacer part/cap
31 recess
32 recess
33 solder repository
34 solder
35 upper end
37 lower end
38 conical segment
40 terminal shank end/ring
41 recess/displacement seat

1. A shank system (10) for an injection molding nozzle (1) that comprises a heated injection material feeding pipe (3) fitted at one end with a nozzle tip (5), said system consisting of a main shank part (20), a thermally insulating spacer part (30) and a terminal shank part (40), the main shank part and the spacer part enclosing the injection material feeding pipe (3) while subtending a radial gap to it, the terminal shank part subtending a recess (41) receiving in sealing manner the free end (4) of said pipe, characterized in that the main shank part (20) and the terminal shank part (40) are soldered to each other and the terminal shank part (40) is hardened.

2. Shank system as claimed in claim 1, characterized in that the terminal shank part (40) is treated.

3. Shank system as claimed in claim 1, characterized in that the terminal shank part (40) is annular.

4. Shank system as claimed in claim 1, characterized in that the main shank part (20) is hardened.

5. Shank system as claimed in claim 4, characterized in that the main shank part (20) is treated.

6. Shank system as claimed in claim 1, characterized in that the mutually soldered shank parts (20, 30, 40) comprise at least segment-wise an external processing contour (K).

7. Shank system as claimed in claim 1, characterized in that the recess (41) of the terminal shank part (40) is fitted with an inside processing contour (I).

8. Shank system as claimed in claim 1, characterized in that at its/their end side the main shank part (20) and/or the spacer part (30) comprise(s) or subtend(s) recesses (21, 31, 32) for at least one adjacent shank part (20, 30, 40).

9. Shank system as claimed in claim 8, characterized in that each recess (21, 31, 32) of the particular adjacent shank part (20, 30, 40) receives the particular adjacent shank part (20, 30, 40) in frictionally locking or mechanically interlocking manner.

10. Shank system as claimed in claim 8, characterized in that the recesses (21, 31, 32) are stepped and/or conically at least segment-wise.

11. Shank system as claimed in claim 8, characterized in that the gap between the shank parts (20, 30, 40) is 0.02 to 0.2 mm wide.

12. Shank system as claimed in claim 1, characterized in that the main shank part (20), the spacer part (30) and/or the terminal shank part (40) comprise a solder repository (23, 33) fashioning the external processing contour (K).

13. Shank system as claimed in claim 12, characterized in that the solder repositories (23, 33) are configured in the region of the recesses (21, 31, 32).

14. Shank system as claimed in claim 1, characterized in that at least one shank part (20, 30, 40) is at least segment-wise conical.

15. Shank system as claimed in claim 1, characterized in that the main shank part (20) is fitted at its upper end (25) with a thread (26).

16. Shank system as claimed in claim 15, characterized in that the thread (26) is an outside thread.

17. Shank system as claimed in claim 11, characterized in that the main shank part (20) and the terminal shank part (40) are made of a substance of high thermal conductivity.

18. Shank system as claimed in claim 1, characterized in that the main shank part (20) and the terminal shank part (40) are made of a hardening tool steel.

19. Shank system as claimed in claim 1, characterized in that the spacer part (30) is made of a thermally poorly conducting substance.

20. Shank system as claimed in claim 19, characterized in that the thermally poorly conducting substance is titanium.

21. A hot runner nozzle (1) fitted with a shank system (10) defined in claim 1.

22. A method for manufacturing a shank system (10) for an injection molding nozzle (1) fitted with an externally heated injection material feeding pipe (3) comprising at its end side a nozzle tip (5), said system comprising a main shank part (20), a thermally insulating spacer part (30) and a terminal shank part (40), the main shank part (20) and the spacer part (30) radially enclosing the injection material feeding pipe (3) at a radial distance from it, the terminal shank part (4) subtending a recess (41) receiving in sealing manner the free end (4) of the injection material feeding pipe (3), in particular as claimed in claim 1, characterized the main shank part (20), the spacer part (30) and the terminal shank part (40) are soldered to each other and in that the terminal shank part is hardened by and concurrently with the soldering procedure.

23. Method as claimed in claim 22, characterized in that the soldering temperature is situated within the range of the transformation temperature of the substance of the terminal shank end (40).

24. Method as claimed in claim 22, characterized in that the terminal shank part (40) is quenched after soldering and then is tempered.

25. Method as claimed in claim 22, characterized in that the main shank part (20) together with the terminal shank part (40) is hardened within the soldering procedure, is quenched following said procedure and then is tempered.

26. Method as claimed in claim 25, characterized in that the mutually soldered shank parts (20, 30, 40) following tempering are fitted at least segment-wise with an external processing contour (K).

27. Method as claimed in claim 25, characterized in that the recess (41) of the terminal shank part (40) following tempering is fitted with an inner processing contour (I).

28. Method as claimed in claim 22, characterized in that soldering is carried out in an oven.
